(19) United States
(12) Patent Application Publication
(10) Pub. No.: US 2007/0180114 A1
(43) Pub. Date: Aug. 2, 2007

(54) Methods and apparatus for allocating an object in computer system

(75) Inventors: Brian Patrick Burgess, Rochester, MN (US); John David Irish, Rochester, MN (US)

Correspondence Address: IBM Corporation;Intellectual Property Law Dept. 917, 3605 Hwy. 52 North, Rochester, MN, 55901, US

(73) Assignee: INTERNATIONAL BUSINESS MACHINES CORPORATION, ARMONK, NY (US)

(21) Appl. No.: 11/344,906

(22) Filed: Feb. 1, 2006

(51) Int. Cl. G06F 15/173

(52) U.S. Cl. 709/226

(57) ABSTRACT

In an aspect, a first method of allocating an object is provided. The first method includes the steps of (1) providing a plurality of registers coupled together to form a ring such that an output of a last register of the plurality of registers is coupled to an input of a first register of the plurality of registers; (2) employing one or more of the plurality of registers to store respective pointers to corresponding free objects; (3) every time period, rotating pointers stored in the ring such that a pointer stored in a current register of the ring is stored in a next consecutive register of the ring and a pointer stored in the last register of the ring is stored in the first register of the ring; and (4) allocating an object based on a pointer output from the last register of the ring. Numerous other aspects are provided.

### FIELD OF THE INVENTION

The present invention relates generally to computer systems, and more particularly to methods and apparatus for allocating an object in a computer system.

### BACKGROUND

During operation, a component of a computer system may request an object, such as a free entry from a buffer or the like. A time required to allocate such an object may be based on a size of the buffer, a distance of the component from the buffer and logic employed to manage the buffer and allocate an object therefrom.

To reduce the time required to allocate such an object, a conventional system may employ a short queue of free buffer entries that is closer to the object-requesting component than the buffer. For example, the short queue may be a first-in, first-out (FIFO) buffer including five free entries from the buffer. The reduced distance of the short queue to the object-requesting component (compared to the buffer) and the reduced number of entries included therein (compared to the buffer) may reduce a time required to allocate the object.

However, in such a conventional system, a large amount of logic is required to manage the short queue. For example, a large amount of logic may be required to remove a free buffer entry from the short queue and to update a count and/or queue pointer (e.g., head pointer) associated with the queue. Similarly, a large amount of logic may be required to add a new free buffer entry to the short queue and to update a count and/or queue pointer (e.g., tail pointer) associated with the queue. Such logic may insert a large delay during object allocation. Consequently, such a conventional system including the short queue may still require a long time to allocate the object. Such a delay becomes especially problematic in a high-speed system (e.g., a system that supports a high-clock frequency). Accordingly, improved methods and apparatus for allocating an object in a computer system are desired.

### SUMMARY OF THE INVENTION

In a first aspect of the invention, a first method of allocating an object is provided. The first method includes the steps of (1) providing a plurality of registers coupled together to form a ring such that an output of a last register of the plurality of registers is coupled to an input of a first register of the plurality of registers; (2) employing one or more of the plurality of registers to store respective pointers to corresponding free objects; (3) every time period, rotating pointers stored in the plurality of registers such that a pointer stored in a current register of the plurality of registers is stored in a next consecutive register of the plurality of registers and a pointer stored in the last register of the plurality of registers is stored in the first register of the plurality of registers; and (4) allocating an object based on a pointer output from one of the plurality of registers designated as an output stage of the ring.

In a second aspect of the invention, a first apparatus for allocating an object is provided. The first apparatus includes object allocation logic including a plurality of registers coupled together to form a ring such that an output of a last register of the plurality of registers is coupled to an input of a first register of the plurality of registers. The object allocation logic is adapted to (1) employ one or more of the plurality of registers to store respective pointers to corresponding free objects; (2) every time period, rotate pointers stored in the plurality of registers such that a pointer stored in a current register of the plurality of registers is stored in a next consecutive register of the plurality of registers and a pointer stored in the last register of the plurality of registers is stored in the first register of the plurality of registers; and (3) allocate an object based on a pointer output from one of the plurality of registers designated as an output stage of the ring.

In a third aspect of the invention, a first system for allocating an object is provided. The first system includes (1) a processor; (2) object allocation logic including a plurality of registers coupled together to form a ring such that an output of a last register of the plurality of registers is coupled to an input of a first register of the plurality of registers; (3) a bus coupled to the object allocation logic and adapted to receive a command from the processor; and (4) command processing logic coupled to the object allocation logic including a buffer having free objects. The object allocation logic is adapted to (a) employ one or more of the plurality of registers to store respective pointers to corresponding free objects; (b) every time period, rotate pointers stored in the plurality of registers such that a pointer stored in a current register of the plurality of registers is stored in a next consecutive register of the plurality of registers and a pointer stored in the last register of the plurality of registers is stored in the first register of the plurality of registers; and (c) allocate an object based on a pointer output from one of the plurality of registers designated as the output stage of the ring in response to the command. Numerous other aspects are provided, as are systems and apparatus in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 illustrates a block diagram of a system for allocating an object in accordance with an embodiment of the present invention.

FIG. 2 illustrates first exemplary fast object allocation logic included in the system of FIG. 1 in accordance with an embodiment of the present invention.

FIG. 3 illustrates second exemplary fast object allocation logic included in the system of FIG. 1 in accordance with an embodiment of the present invention.

FIG. 4 illustrates third exemplary fast object allocation logic included in the system of FIG. 1 in accordance with an embodiment of the present invention.

### DETAILED DESCRIPTION

The present invention provides methods and apparatus for allocating an object in a computer system. For example, the present invention may provide a system adapted to reduce a time required to allocate an object, such as a free entry from a buffer or the like, to a requesting component of the system. In contrast to the short queue of a conventional system, the system of the present invention may include logic forming a wheel structure adapted to store a small number of free buffer entries closer to the requesting component than the buffer. Entries stored in the wheel structure may continuously rotate (e.g., every clock cycle), and therefore, the wheel structure may define a short data path from which an entry may be allocated and/or through which a new entry may be added. For example, an entry may always be allocated from a first known portion or stage of the wheel structure and an entry may always be added to a second known portion or stage of the wheel structure. Additionally, the wheel structure does not require the same management as the short queue, and therefore, may include a reduced amount of logic. More specifically, the wheel structure does not have to update a count and/or pointers (e.g., head and/or tail pointers) associated with the entries stored in the wheel structure, thereby further shortening respective data paths from which an entry may be allocated from the wheel structure and through which a new entry may be added to the wheel structure. The short data path for allocating an entry therefrom and/or adding an entry thereto enables the wheel structure to reduce a time required to allocate an object. Consequently, the wheel structure may be especially useful in a system which supports a high-clock frequency. In this manner, the present invention provides methods and apparatus for allocating an object.

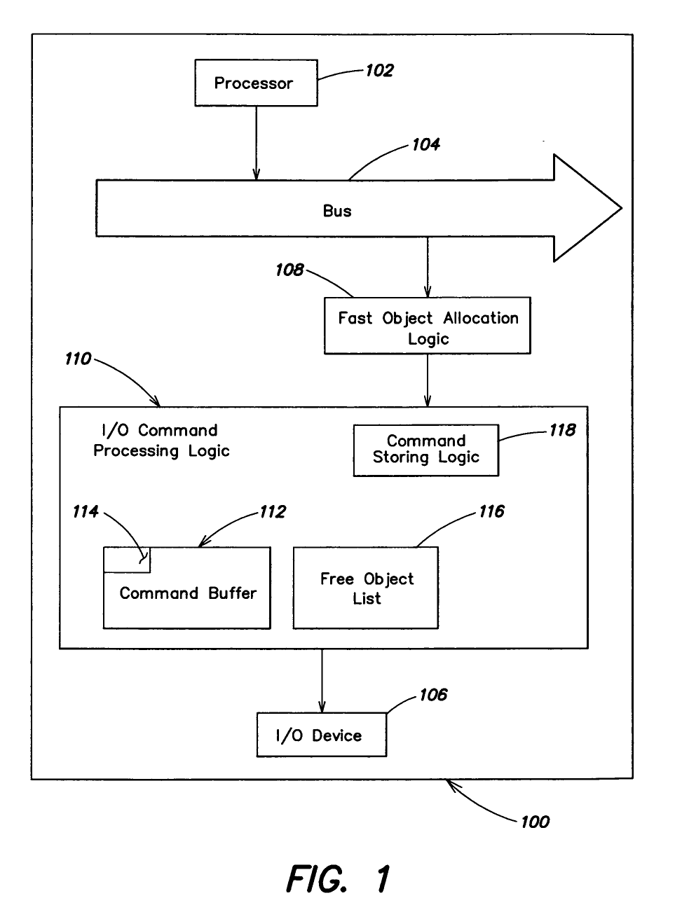

FIG. 1 illustrates a block diagram of a system 100 for allocating an object in accordance with an embodiment of the present invention. With reference to FIG. 1, the system 100 may include one or more processors 102 (only one shown) coupled via a bus 104 to one or more input/output devices 106 (only one shown). A processor 102 may provide a command every time period (e.g., every clock cycle) for an I/O device 106 on the bus 104. Further, the system 100 may support a high-clock frequency (e.g., 2 GHz), and therefore, a processor may frequently provide a command (e.g., every 500 ps) on the bus 104. The system 100 may include logic adapted to allocate at least one object (e.g., a free entry from a command buffer (described below)) for each command. More specifically, the system 100 may include fast object allocation logic 108 coupled to the bus 104. The fast object allocation logic 108 may be adapted to reduce logic delay while allocating the at least one free object for each command provided on the bus 104. Consequently, the logic may be adapted to allocate an object every time period (e.g., clock cycle of 500 ps).

Additionally, the system 100 may include I/O command processing logic 110 coupled to the fast object allocation logic 108 and the one or more I/O devices 106. The I/O command processing logic 110 may include a command buffer 112 including objects (e.g., buffer entries) 114. Additionally, the I/O command processing logic 110 may include or maintain a free object list 116 adapted to indicate available objects of the command buffer 112. Additionally, the I/O command processing logic 110 may include command storing logic 118 adapted to take a command provided on the bus 104 by a processor 102 and store the command in a free object allocated for the command. Because a command may be placed on the bus 104 every clock cycle, the command storing logic 118 may be required to store such a command every clock cycle. However, the command buffer may be large (e.g., 64 100-bit wide entries), and therefore, may include a large number of available entries. Consequently, the free buffer list 116 may be large and may require a large time period (e.g., larger than one clock cycle) to maintain and to allocate an entry therefrom. Thus, the command storing logic 118 may be proximate to the fast object allocation logic 108 (e.g., closer to the fast object allocation logic 118 than the command buffer 112), which may allocate a free object every time period (e.g., clock cycle) even in systems 110 that support a high-clock frequency. For each command that the command storing logic 118 takes from the bus 104, the command storing logic 118 may request a free object from the fast object allocation logic 108 to store the command. Once a free object is received from the fast object allocation logic 108, the object may be allocated for the command until the command completes.

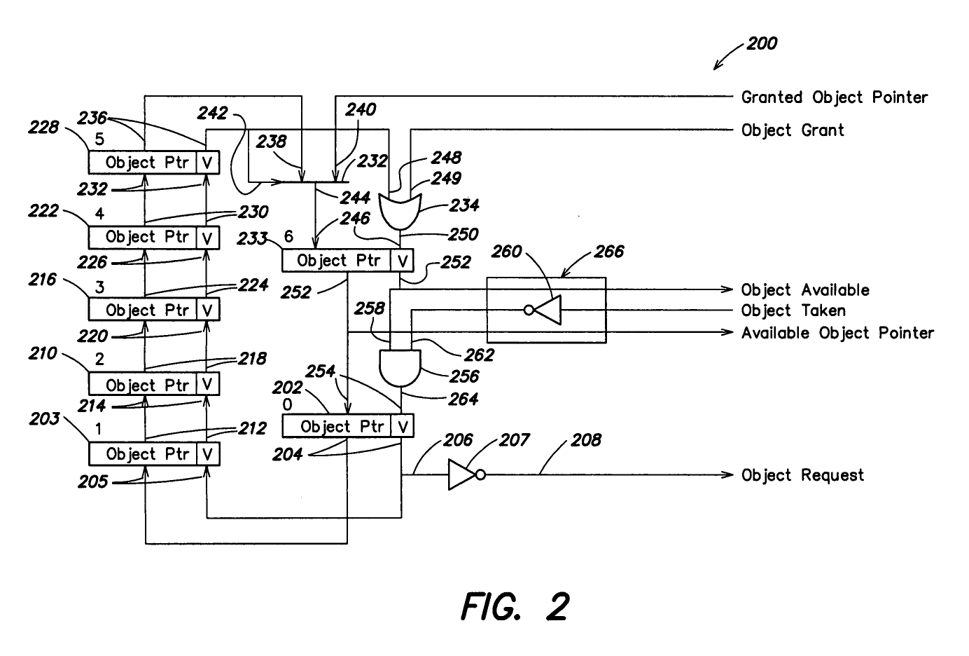

Details of first through third exemplary fast object allocation logic are described below with reference to FIGS. 2-4, respectively. FIG. 2 illustrates first exemplary fast object allocation logic 200 included in the system 100 of FIG. 1 in accordance with an embodiment of the present invention. With reference to FIG. 2, the first exemplary fast object allocation logic 200 may include a plurality of registers coupled together to form a ring or wheel structure such that an output of a last register of the plurality of registers is coupled to an input of a first register of the plurality of registers. For example, the fast object allocation logic 200 may include a first register 202 adapted to store a pointer to a free object 114 in the command buffer 112 of the system 100 and a status bit V (e.g., valid bit) associated therewith, which indicates whether the pointer to the free object is valid. The first register 202 may be coupled to a second register 203 adapted to store a pointer to a free object 114 in the command buffer 112 of the system 100 and a status bit V associated therewith, which indicates whether the pointer to the free object 114 is valid. More specifically, an output 204 of the first register 202 may be coupled to an input 205 of the second register 203.

Further, the output 204 of the first register 202 may be coupled to an input 206 of a first inverter 207. A signal output via an output 208 of the first inverter 207 may serve as signal Object Request employed by the fast object allocation logic 200 to request a new free object 114 (e.g., in response to allocating an object from one of the plurality of registers designated as an output stage, such as the last register).

The second register 203 may be coupled to a third register 210 adapted to store a pointer to a free object 114 in the command buffer 112 and a status bit V associated therewith, which indicates whether the pointer to the free object 114 is valid. More specifically, an output 212 of the second register 203 may be coupled to an input 214 of the third register 210. Further, the third register 210 may be coupled to a fourth register 216 adapted to store a pointer to a free object 114 in the command buffer 112 and a status bit V associated therewith, which indicates whether the pointer to the free object 114 is valid. More specifically, an output 218 of the third register 210 may be coupled to an input 220 of the fourth register 216. Similarly, the fourth register 216 may be coupled to a fifth register 222 adapted to store a pointer to a free object 114 in the command buffer 112 and a status bit V associated therewith, which indicates whether the pointer to the free object 114 is valid. More specifically, an output 224 of the fourth register 216 may be coupled to an input 226 of the fifth register 222. Further, the fifth register 222 may be coupled to a sixth register 228 adapted to store a pointer to a free object 114 in the command buffer 112 and a status bit V associated therewith, which indicates whether the pointer to the free object 114 is valid. More specifically, an output 230 of the fifth register 222 may be coupled to an input 232 of the sixth register 228.

Additionally, the sixth register 228 may be coupled to a seventh register 230, which may be the last register of the ring or wheel structure, via a multiplexer 232 and an OR gate 234. The seventh register 230 is adapted to store a pointer to a free object 114 in the command buffer 112 and a status bit V associated therewith, which indicates whether the pointer to the free object 114 is valid. More specifically, an output 236 of the sixth register 228 may be coupled to a first input 238 of the multiplexer 232 such that the pointer to the free object 114 stored in the sixth register 228 may be input thereby. In response to a previous request (via signal Object Request) for a new free object 114 by the fast object allocation logic 200, the fast object allocation logic 200 may be granted the new free object 114 and receive the new object 114 (e.g., a pointer thereto) via a second input 240 of the multiplexer 232. The multiplexer 232 is adapted to selectively output data input by the first or second input 238, 240 thereof. More specifically, the output 236 of the sixth register 228 may be coupled to a third input 242 (e.g., a control input) of the multiplexer 232 such that the status bit V stored by the sixth register 228 may be input thereby. Thus, the multiplexer 232 may output, via an output 244, the pointer to the free object 114 (from the sixth register 228) input via the first input 238 or the pointer to the new free object 114 input via the second input 240. The output 244 of the multiplexer 232 may be coupled to an input 246 of the seventh register 230. In this manner, a pointer to an object 114 may be stored in the seventh register 230.

Further, an output 236 of the sixth register 228 may be coupled to a first input 248 of the OR gate 234 such that the status bit V stored in the sixth register 228 may be input thereby. When the fast object allocation logic 200 is granted a new free object 114 (e.g., a pointer thereto), the logic 200 may also receive signal Object Grant, which indicates the new free object 114 has been received, via a second input 249 of the OR gate 234. The OR gate 234 is adapted to perform Boolean algebra and output the result, which may serve as a status bit V associated with the object pointer output from the multiplexer 232, via an output 250. The output 250 may be coupled to the input 246 of the seventh register 230. In this manner, a status bit V associated with the object pointer output from the multiplexer 232 may be stored by a register of the plurality of registers designated as an input stage (e.g., the seventh register 230).

An output 252 of the seventh register 230 may be coupled to an input 254 of the first register 202 via an AND gate 256. More specifically, the output 252 of the seventh register 230 may be coupled to the input 254 of the first register 202 such that a pointer to a free object 114 output from the seventh register 230 may be input by the first register 202. Additionally, the output 252 of the seventh register 230 may be coupled to a first input 258 of the AND gate 256 such that the status bit V associated with the object pointer output by the seventh register 230 may be input thereby. Such a status bit V may serve as a signal Object Available which may indicate the object pointer output from the seventh register 230 is valid. When signal Object Available indicates the object pointer output from the seventh register 230 is valid, such an object pointer may serve as an available object pointer, which identifies a free object that may be allocated by the fast object allocation logic 200. In this manner, a register (e.g., the seventh register 230) of the plurality of registers may serve as a designated output stage). Additionally, the fast object allocation logic 200 may receive signal Object Taken, which may indicate a free object 114 identified by the logic 200 has been allocated to the system 100 (e.g., to command storing logic 118 therein). Signal Object Taken may be coupled via a second inverter 260 to a second input 262 of the AND gate 256. The AND gate 256 is adapted to perform Boolean algebra on data input via the first and second inputs 258, 262 thereof and output the result, which may serve as a status bit V associated with the object pointer output from the seventh register 230, via an output 264 which may be coupled to the input 254 of the first register 202.

In this manner, the first through seventh registers 202, 203, 210, 216, 222, 228, 230 may serve as a first through seventh stage stage 0 - stage 6 of the fast object allocation logic 200, each of which may store a pointer to an object 114 and status bit V associated therewith. The size of the ring or wheel structure may be determined by the number of cycles between a request for an object 114 from the master free list (e.g., free object list 116) and receipt of a pointer to the granted object 114. For example, if the number of cycles is N, the wheel structure may be include N+2 stages (e.g., will be N+2 cycles around). The fast object allocation logic 200 is exemplary and assumes a pointer to a new object 114 may be received by the logic 200 five cycles after a request for such object. However, a different logic configuration may be employed. Additionally or alternatively, a larger or smaller amount of logic and/or different logic may be employed.

In operation, a pointer to an object 114 and status bit associated therewith may travel through the fast object allocation logic 200 over time. For example, during a first clock cycle, the first through seventh registers 202, 203, 210, 216, 222, 228, 230 may store first through seventh pointers to objects 114 and status bits associated therewith, respectively. During a second clock cycle, the first register 202 may store the seventh pointer to an object 114 and status bit associated therewith, and the second through seventh registers 203, 210, 216, 222, 228, 230 may store the first through sixth pointers to objects 114 and status bits associated therewith, respectively. Pointers to objects and status bits associated therewith may travel through the fast object allocation logic 200 in a similar manner during subsequent time periods. Further, data output from a select register (e.g., the seventh register 230 which serves as a designated output stage) may identify an object to be allocated. Additionally, a pointer to a new object may be input by a select register (e.g., the seventh register 230).

Assume during the first time period that the status bit V associated with the seventh pointer to an object, which is stored by the seventh register 230, indicates the seventh pointer is valid. Therefore, signal Object Available may be asserted to indicate (e.g., to the command storing logic 118) that the object 114 pointed to by the seventh pointer is available. If such object 114 is allocated to the command storing logic 118, the fast object allocation logic 200 may receive an asserted signal Object Taken (e.g., from the command storing logic 118). During the second time period, even though the object 114 pointed to by the seventh pointer has been allocated, the seventh pointer may be stored in the first register 202. However, the AND gate 256 may output a status bit V, which is stored by the first register 202, indicating the seventh pointer is no longer valid. Consequently, signal Object Request may be asserted. In this manner, during the second time period, the fast object allocation logic 200 may request a pointer to a new free object 114 (e.g., to replace the object 114 that was allocated from the seventh register 230 during the first time period).

As stated, it is assumed a pointer to a new object 114 (if available) may be received by the logic 200 five cycles after a request for such an object 114. Therefore, during a seventh clock cycle, the seventh pointer and status bit V associated therewith, which indicates the seventh pointer is invalid, may be stored by the sixth register 228. The status bit V associated with seventh pointer may serve as a control signal for the multiplexer 232 and cause the multiplexer 232 to output the pointer to a new object (e.g., granted object pointer), which is received by the logic 200, from the multiplexer 232 such that the seventh register 230 stores the granted object pointer in the eighth time period. As stated, when the fast object allocation logic 200 receives the new object, signal Object Grant may be asserted. Consequently, the OR gate 234 may output a valid bit, which is stored by the seventh register 230, indicating the granted object pointer stored by the seventh register 230 is valid.

In this manner, during any time period, a valid pointer to a free object 114 (available object pointer) output from the seventh stage 230 of the fast object allocation logic 200 may be allocated (e.g., to command storing logic 118), and thus, the free object 114 pointed to by the pointer may be allocated. The data paths employed to allocate a free object 114 from the fast object allocation logic 200 (e.g., to output signal Object Available and the available object pointer) include a reduced amount of logic compared to that of the short queue of the conventional system, and therefore, the fast object allocation logic 200 may reduce logic delay while allocating a free object 114.

Similarly, during any time period, a granted pointer to a new free object 114 received by the fast object allocation logic 200 may be stored in the seventh register 230 (assuming the status bit V output from the sixth register 228 indicates the object pointer output from the sixth register 228 is invalid). The data paths employed to receive and store a granted pointer to a new free object 114 in the fast object allocation logic 200 (e.g., to input signal Object Grant and the newly-received free object (granted object pointer) may include a reduced amount of logic compared to that of the short queue of the conventional system, and therefore, the fast object allocation logic 200 may reduce a logic delay for storing a new pointer to an object 114 therein.

Because the fast object allocation logic 200 (1) stores and manages a reduced amount of pointers to free objects 114 compared to the free object list 116; (2) is proximate the command storing logic 118; and/or (3) reduces data paths employed to allocate a free object 114 from and/or receive and store a new pointer to a free object 114 in the fast object allocation logic 200, the fast object allocation logic 200 may provide methods and apparatus for reducing delay while allocating a free object 114.

The scenario described above is exemplary, and therefore, pointers to objects 114 may be allocated from and/or stored in the fast object allocation logic 200 in a different manner. For example, during the seventh time period, a pointer to a new free object may not be received by the fast object allocation logic 200, and therefore, signal Object Grant may not be asserted. Consequently, the status bit V associated with the object pointer stored by the seventh register 230 during the eighth time period may remain invalid (e.g., may continue to indicate the object pointer associated therewith is invalid). Thus, the invalid pointer may form a hole in the ring or wheel structure that travels around the ring or wheel structure until such invalid pointer is stored by the sixth register 228 during a time period when a new pointer to a free object 114 is received by the fast object allocation logic 200. One or more holes may be formed in the ring or wheel structure in a similar manner. Due to the hole, the fast object allocation logic 200 will be unable to allocate an object 114 in a subsequent time period (e.g., the ninth clock cycle). Consequently, the system 100 (e.g., command storing logic 118 included therein) may have to wait one more cycles before the fast object allocation logic 200 may allocate a free object.

As a further example, assume that a pointer held in the stage 0 register 202 in a cycle is not valid. In the cycle, the Object Request signal may be active. In the next cycle the invalid pointer may move to the stage 1 register 203 and the Object Request signal may be based on the status bit V that is now stored in the stage 0 register 202. If the pointer now stored in the stage 0 register 202 is also not valid the Object Request line may remain active, which may represent a second request for an object. In the next 4 cycles, the original invalid pointer may move through the registers 210, 216, 222, 228 of stages 2 through 4 to the stage 5 register 228. In the cycle that the invalid pointer is stored in the stage 5 register 228, a new object pointer should be arriving from the master free list (e.g., free object list 116) in response to the previous object 114 request (if an object 114 was available to be granted), and therefore, signal Object Grant may be activated (e.g., asserted). If signal Object Grant is asserted in the cycle, the new pointer may be loaded into the stage 6 register 230. In cycle 6 the Object Available signal may be asserted. If the object 114 is needed (and taken), the Object Taken signal may be asserted by the function (e.g., command storing logic 118) that uses the object. The Object Taken signal may cause the status bit V stored in the stage 0 register 202 to go inactive (e.g., be deasserted) in the next cycle which will result in an Object Request being made. Alternatively, if the object 114 is not taken from the stage 6 register 230, the object 114 may go around the ring or wheel structure and become available again in seven cycles. If the Object Grant signal was not active (e.g., deasserted) as data is output from the stage 5 register 228 for the original invalid pointer, the invalid pointer may go around the ring or wheel structure again and cause a new object request to be made when such invalid pointer reaches the stage 0 register 202. In some embodiments, the master free list (e.g., free buffer list 116) may treat the Object Request signal as a separate request in each cycle that may be granted immediately or discarded.

A disadvantage to the ring or simple wheel structure of FIG. 2 may occur when the master free list is empty and there are less than N+2 valid object pointers on the wheel structure. Consequently, invalid object pointers may repeatedly go around the wheel structure so that every N+2 cycles (e.g., or more frequently) an invalid object pointer may cause the Object Available signal to be deasserted. The repeating deasserted Object Available signal may coincide with a repeating need for an object (e.g., by the command storing logic 118).

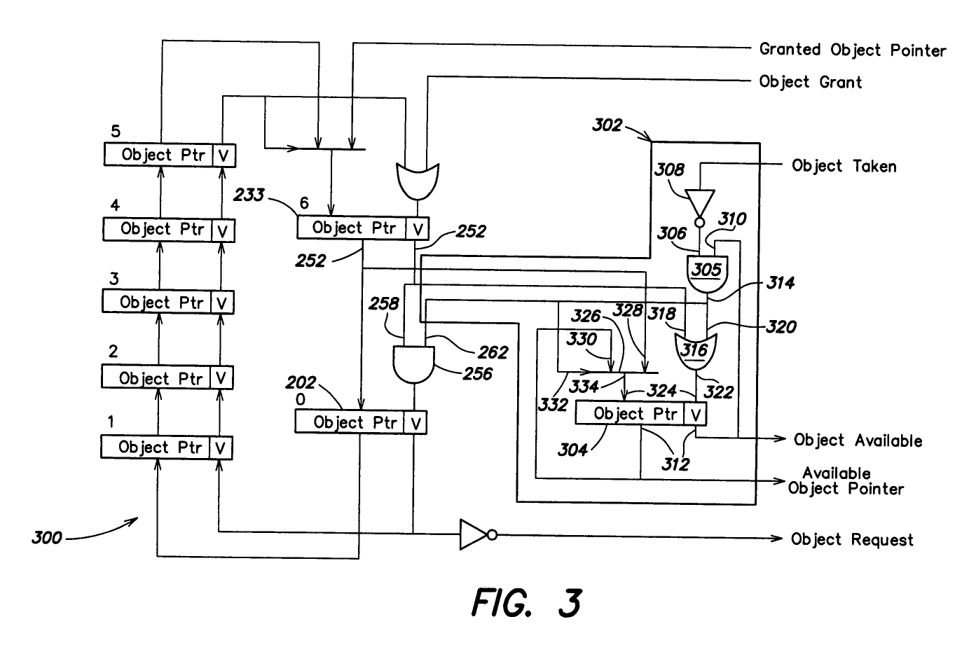

However, design of the first exemplary fast object allocation logic 200 may be modified to reduce a number of times the system 100 may have to wait one or more cycles before the fast object allocation logic 200 allocates a free object 114. More specifically, a first portion 266 of the first exemplary fast object allocation logic 200 may be modified. FIG. 3 illustrates second exemplary fast object allocation logic 300 included in the system 100 of FIG. 1 in accordance with an embodiment of the present invention. With reference to FIG. 3, the second exemplary fast object allocation logic 300 may be similar to the first exemplary fast object allocation logic 200. However, in the second exemplary fast object allocation logic 300, the first portion 266 may be replaced by a second portion 302. The second portion 302 may be adapted to reduce a number of times the system 100 may have to wait one or more cycles before the fast object allocation logic 300 allocates a free object 114. For convenience, only portions of the second exemplary fast object allocation logic 300 which differ from the first exemplary fast object allocation logic 200 are described. The second portion 302 may include an eighth register 304, a holding register, adapted to store an available object 114 from the ring or wheel structure, such that a free object 114 may be allocated from the second exemplary fast object allocation logic 300 even when the seventh register 230 stores an invalid object pointer. In this manner, the second exemplary fast object allocation logic 300 may reduce a number of times the system 100 may have to wait one or more cycles before the fast object allocation logic 200 allocates a free object 114.

The second portion 302 of the logic 300 may include an AND gate 305. Signal Object Taken may be coupled to a first input 306 of the AND gate 305 via an inverter 308. A second input 310 of the AND gate 305 may be coupled to an output 312 of the holding register 304 such that a status bit V, which indicates a status of an object pointer associated therewith, output from the holding register 304 may be input via the second input 310. The AND gate 305 may be adapted to perform Boolean algebra on data input via the first and second inputs 306, 310 of the AND gate 305 and output the result via an output 314. The AND gate 305 may be coupled to an OR gate 316. More specifically, the output 252 of the seventh register 230 may be coupled to a first input 318 of the OR gate 316 such that the status bit V output from the seventh register 230 may be input via the first input 318. Further, the output 314 of the AND gate 305 may be coupled to a second input 320 of the OR gate 316. The OR gate 316 is adapted to perform Boolean algebra on data input by the first and second inputs 318, 320 thereof and output the result via an output 322. The output 322 of the OR gate 316 may be coupled to an input 324 of the holding register 304 such that data output from the OR gate 316 may serve as a status bit V, which indicates a status of an associated object pointer, stored by the holding register 304.

Additionally, the output 314 of the AND gate 305 may be coupled to a second input 262 of the AND gate 256. Therefore, respective status bits V stored in the first and holding registers 202, 304 may be based (in part) on signal Object Taken.

Further, the output 252 of the seventh register 230 may be coupled to the holding register 304 via a second multiplexer 326. More specifically, the output 252 of the seventh register 230 may be coupled to a first input 328 of the of the second multiplexer 326 such that an object pointer output from the seventh register 230 may be input by the first input 328. Additionally, the output 312 of the holding register 304 may be coupled to a second input 330 of the second multiplexer 326 such that an object pointer output from the holding register 304 may be input via the second input 330. Additionally, the output 314 of the AND gate 305 may be coupled to a third input 332 (e.g., a control input) of the second multiplexer 326 such that data output from the AND gate 305 may serve as a control signal for the second multiplexer 326. The second multiplexer 326 may be adapted to selectively output via output 334 the object pointer output from the seventh register 230 or the object pointer output from the holding register 304. The output 334 of the second multiplexer 326 may be coupled to the input 324 of the holding register 304 such that the object pointer output from the second multiplexer 326 may be stored by the holding register 304.

An object pointer output from the holding register 304 may serve as an available object pointer, which identifies a free object that may be allocated by the fast object allocation logic 300. Additionally, a status bit V output from the holding register 304 may serve as a signal Object Available which may indicate the object pointer output from the holding register 304 is valid.

The fast object allocation logic 300 may receive signal Object Taken to indicate a free object described by the logic 300 has been allocated to the system 100 (e.g., to command storing logic 118 therein). During operation, as stated, respective status bits V stored in the first and holding registers 202, 304 may be based (in part) on signal Object Taken.

The holding register 304 at the output of the ring or wheel structure may reduce the impact of holes in the ring or wheel structure on object allocation. More specifically, the holding register 304 may reduce a scenario in which one or more invalid object pointers may repeatedly go around the wheel structure so that every N+2 cycles (e.g., or more frequently) an invalid object pointer may cause the Object Available signal to be deasserted. However, the second exemplary fast object allocation logic 300 may still be susceptible to holes (although less than the first fast object allocation logic 200). Further, the second portion 302 may add logic to the potentially timing critical path of signal Object Taken. For example, the timing of signal Object Taken may depend on the inverter 308, AND gate 305 and/or OR gate 316. More specifically, the inverter 308, AND gate 305 and/or OR gate 316 may introduce a logic delay to signal Object Taken.

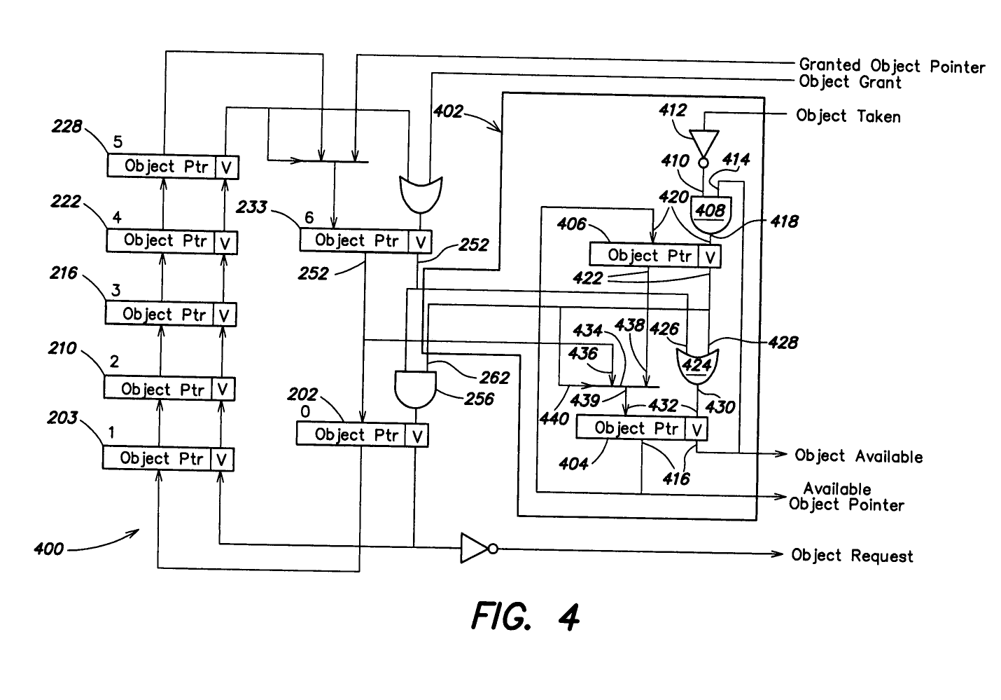

Therefore, to further reduce hole susceptibility and to reduce the logic delay introduced to signal Object Taken, design of the second exemplary fast object allocation logic 300 may be modified. More specifically, the second portion 302 of the second exemplary fast object allocation logic 300 may be modified. FIG. 4 illustrates third exemplary fast object allocation logic 400 included in the system of FIG. 1 in accordance with an embodiment of the present invention. With reference to FIG. 4, the third exemplary fast object allocation logic 400 may be similar to the second exemplary fast object allocation logic 300. However, in the third exemplary fast object allocation logic 400, the second portion 302 may be replaced by a third portion 402. The third portion 402 may be adapted to reduce a number of times the system 100 may have to wait one or more cycles before the fast object allocation logic 400 allocates a free object (e.g., compared to the second exemplary fast object allocation logic 300). Additionally or alternatively, the third portion 402 may be adapted to reduce logic delay introduced to signal Object Taken (e.g., compared to the second portion 302), thereby improving object allocation. For convenience, only portions of the third exemplary fast object allocation logic 400 which differ from the second exemplary fast object allocation logic 300 are described. The third portion 402 may include first and second holding registers 404, 406. The first and second holding registers 404, 406 may be adapted to store an available object 114 from the ring or wheel structure, such that a free object 114 may be allocated from the third exemplary fast object allocation logic 400 even when the seventh 230 register (and possibly the sixth register 228) stores an invalid object pointer. In this manner, the third exemplary fast object allocation logic 400 may reduce a number of times the system 100 may have to wait one or more cycles before the fast object allocation logic 400 allocates a free object 114.

The third portion 402 of the logic 400 may include an AND gate 408. Signal Object Taken may be coupled to a first input 410 of the AND gate 408 via an inverter 412. A second input 414 of the AND gate 408 may be coupled to an output 416 of the first holding register 404 such that a status bit V, which indicates a status of an object pointer associated therewith, output from the first holding register 404 may be input via the second input 414. The AND gate 408 may be adapted to perform Boolean algebra on data input via the first and second inputs 410, 414 of the AND gate 408 and output the result via an output 418. The AND gate 408 may be coupled the second holding register 406. More specifically, the output 418 of the AND gate 408 may be coupled to an input 420 of the second holding register 406 such that a status bit V output from the AND gate 408 may be input by the second holding register 406. Additionally, the output 416 of the first holding register 404 may be coupled to the input 420 of the second holding register 406 such that an object pointer output from the first holding register 404 may be input by the second holding register 406.

Further, an output 422 of the second holding register 406 may be coupled to an OR gate 424. More specifically, the output 252 of the seventh register 230 may be coupled to a first input 426 of the OR gate 424 such that the status bit V output from the seventh register 230 may be input via the first input 426. Further, the output 422 of the second holding register 406 may be coupled to a second input 428 of the OR gate 424. The OR gate 424 is adapted to perform Boolean algebra on data input by the first and second inputs 426, 428 thereof and output the result via an output 430. The output 430 of the OR gate 424 may be coupled to an input 432 of the first holding register 404 such that data output from the OR gate 424 may serve as a status bit V, which indicates a status of an associated object pointer, stored by the first holding register 404.

Additionally, the output 422 the second holding register 406 may be coupled to the second input 262 of the AND gate 256. Therefore, respective status bits V stored in the first register 202 and first and second holding registers 404, 406 may be based (in part) on signal Object Taken.

Further, the output 252 of the seventh register 230 may be coupled to the first holding register 404 via a second multiplexer 434. More specifically, the output 252 of the seventh register 230 may be coupled to a first input 436 of the of the second multiplexer 434 such that an object pointer output from the seventh register 230 may be input by the first input 436. Additionally, the output 422 of the second holding register 406 may be coupled to a second input 438 of the second multiplexer 434 such that an object pointer output from the second holding register 406 may be input via the second input 438. Additionally, the output 422 of the second holding register 406 may be coupled to a third input 440 (e.g., a control input) of the second multiplexer 434 such that a status bit V output from the second holding register 406 may serve as a control signal for the second multiplexer 434. The second multiplexer 434 may be adapted to selectively output via output 439 the object pointer output from the seventh register 230 or the object pointer output from the second holding register 406. The output 439 of the second multiplexer 434 may be coupled to the input 432 of the first holding register 404 such that the object pointer output from the second multiplexer 434 may be stored by the second holding register 404.

An object pointer output from an output 416 of the second holding register 404 may serve as an available object pointer, which identifies a free object 114 which may be allocated by the fast object allocation logic 400. Additionally, a status bit V output from the second holding register 404 may serve as a signal Object Available which may indicate the object pointer output from the second holding register 404 is valid.

The fast object allocation logic 400 may receive signal Object Taken to indicate a free object 114 identified by the logic 400 has been allocated to the system 100 (e.g., to command storing logic 118 therein). During operation, as stated, respective status bits V stored in the first register 202 and first and second holding registers 404, 406 may be based (in part) on signal Object Taken.

The first and second holding register 404, 406 may reduce the impact of holes in the large ring or wheel structure (e.g., formed by registers 202, 203, 210, 216, 222, 228, 230) on object allocation by forming a smaller ring or wheel structure (e.g., a two-cycle wheel structure) including the first and second holding registers 404, 406 at the output of the larger ring or wheel structure. The first and second holding registers 404, 406 may reduce a scenario in which one or more invalid object pointers may repeatedly go around the wheel structure so that every N+2 cycles (e.g., or more frequently) an invalid object pointer may cause the Object Available signal to be deasserted. However, the third exemplary fast object allocation logic 400 may still be susceptible to holes (although less than the first and second fast object allocation logic 200, 300). For example, if only one free object 114 is left in the system 100, one or more invalid object pointers may repeatedly go around the ring or wheel structure so that an invalid object pointer may cause the Object Available signal to be repeatedly deasserted during subsequent cycles. Further, the third portion 402 may minimize the potentially timing critical path of signal Object Taken. More specifically, in contrast to the second exemplary fast object allocation logic 300, the timing of signal Object Taken may not depend on an OR gate 424 and an AND gate 256. More specifically, the OR gate 424 and AND gate 256 may not introduce a logic delay to signal Object Taken. Consequently, a number of times the third fast object allocation logic 400 is unable to allocate a free object may be reduced (e.g., compared to the first and second fast object allocation logic 200, 300).

In summary, the present invention may provide the fast object allocation logic 108, 200, 300, 400 to reduce and/or eliminate logic delay while allocating an object. For example, one or more of the plurality of registers may be employed to store respective pointers to corresponding free objects. Every time period, pointers stored in the ring or wheel structure may be rotated such that a pointer stored in a current register of the ring or wheel structure is stored in a next consecutive register of the ring or wheel structure and a pointer stored in the last register of the ring or wheel structure is stored in the first register of the ring or wheel structure. An object 114 may be allocated from the fast object allocation logic 108, 200, 300, 400 based on a pointer output from the designated output stage (e.g., last register) of the ring or wheel structure. As described above, data stored in the ring or wheel structure may rotate (e.g., continuously and automatically). The rotation of data enables data to be easily added to and/or easily removed from the ring or wheel structure via a short data path.

In this manner, the present methods and apparatus may reduce and/or minimize logic levels in paths employed to allocate objects 114 while avoiding problems of the short queue employed by a conventional system. Consequently, objects 114, such as buffers from a command buffer 112, which may be very large and located a long distance away from a system component that requires the buffer, may be allocated efficiently. Therefore, the present methods and apparatus may be useful when implementing logic in a system 100 that supports a high clock frequency because a number of levels allowed between latch or register stages may be severely limited in such a system 100.

The foregoing description discloses only exemplary embodiments of the invention. Modifications of the above disclosed apparatus and methods which fall within the scope of the invention will be readily apparent to those of ordinary skill in the art. For instance, although the fast object allocation logic 108, 200, 300, 400 described above store pointers to free objects 114, in some embodiments, the fast object allocation logic 108, 200, 300, 400 may store the objects 114 themselves.

Accordingly, while the present invention has been disclosed in connection with exemplary embodiments thereof, it should be understood that other embodiments may fall within the spirit and scope of the invention, as defined by the following claims.

The invention claimed is:

1. A method of allocating an object, comprising:
providing a plurality of registers coupled together to form a ring such that an output of a last register of the plurality of registers is coupled to an input of a first register of the plurality of registers;
employing one or more of the plurality of registers to store respective pointers to corresponding free objects;
every time period, rotating pointers stored in the plurality of registers such that a pointer stored in a current register of the plurality of registers is stored in a next consecutive register of the plurality of registers and a pointer stored in the last register of the plurality of registers is stored in the first register of the plurality of registers; and
allocating an object based on a pointer output from one of the plurality of registers designated as an output stage of the ring.

2. The method of claim 1 further comprising employing the one or more of the plurality of registers to store respective status bits associated with the pointers stored thereby.

3. The method of claim 1 further comprising allocating the object based on a status bit output from the designated output stage of the ring.

4. The method of claim 1 further comprising storing a pointer to a new object in the one of the plurality of registers designated as the input stage of the ring.

5. The method of claim 4 further comprising storing a status bit associated with the pointer to the new object in the designated input stage of the ring.

6. The method of claim 4 further comprising reducing delay of a logic path employed to store the pointer to the new object in the designated input stage of the ring.

7. The method of claim 1 further comprising reducing delay of a logic path employed to allocate the object based on the pointer output from the designated output stage of the ring by employing a second ring of registers coupled to the designated output stage.

8. An apparatus for allocating an object, comprising:
object allocation logic including a plurality of registers coupled together to form a ring such that an output of a last register of the plurality of registers is coupled to an input of a first register of the plurality of registers;
wherein the object allocation logic is adapted to:
employ one or more of the plurality of registers to store respective pointers to corresponding free objects;
every time period, rotate pointers stored in the plurality of registers such that a pointer stored in a current register of the plurality of registers is stored in a next consecutive register of the plurality of registers and a pointer stored in the last register of the plurality of registers is stored in the first register of the plurality of registers; and
allocate an object based on a pointer output from one of the plurality of registers designated as an output stage of the ring.

9. The apparatus of claim 8 wherein the object allocation logic is further adapted to employ the one or more of the plurality of registers to store respective status bits associated with the pointers stored thereby.

10. The apparatus of claim 8 wherein the object allocation logic is further adapted to allocate the object based on a status bit output from the designated output stage of the ring.

11. The apparatus of claim 8 wherein the object allocation logic is further adapted to store a pointer to a new object in one of the plurality of registers designated as the input stage of the ring.

12. The apparatus of claim 11 wherein the object allocation logic is further adapted to store a status bit associated with the pointer to the new object in the designated input stage of the ring.

13. The apparatus of claim 11 wherein the object allocation logic is further adapted to reduce delay of a logic path employed to store the pointer to the new object in the designated input stage of the ring.

14. The apparatus of claim 8 wherein the object allocation logic is further adapted to reduce delay of a logic path employed to allocate the object based on the pointer output from the designated output stage of the ring by employing a second ring of registers coupled to the designated output stage.

15. A system for allocating an object, comprising:
a processor;
object allocation logic including a plurality of registers coupled together to form a ring such that an output of a last register of the plurality of registers is coupled to an input of a first register of the plurality of registers;
a bus coupled to the object allocation logic and adapted to receive a command from the processor; and
command processing logic coupled to the object allocation logic including a buffer having free objects;
wherein the object allocation logic is adapted to:
employ one or more of the plurality of registers to store respective pointers to corresponding free objects;
every time period, rotate pointers stored in the plurality of registers such that a pointer stored in a current register of the plurality of registers is stored in a next consecutive register of the plurality of registers and a pointer stored in the last register of the plurality of registers is stored in the first register of the plurality of registers; and
allocate an object based on a pointer output from one of the plurality of registers designated as the output stage of the ring in response to the command.

16. The system of claim 15 wherein the object allocation logic is further adapted to employ the one or more of the plurality of registers to store respective status bits associated with the pointers stored thereby.

17. The system of claim 15 wherein the object allocation logic is further adapted to allocate the object based on a status bit output from the designated output stage of the ring.

18. The system of claim 15 wherein the object allocation logic is further adapted to store a pointer to a new object in one of the plurality of registers designated as the input stage of the ring.

19. The system of claim 18 wherein the object allocation logic is further adapted to store a status bit associated with the pointer to the new object in the designated input stage of the ring.

20. The system of claim 15 wherein the object allocation logic is further adapted to reduce delay of a logic path employed to allocate the object based on the pointer output from the designated output stage of the ring by employing a second ring of registers coupled to the designated output stage.
